(19) United States
(12) Patent Application Publication
(10) Pub. No.: US 2011/0031835 A1
(43) Pub. Date: Feb. 10, 2011

(54) MOTOR

(76) Inventors: Harry Hang Fung CHANG, Hong Kong (CN); Yiu Leung Man, Hong Kong (CN); Yao Fei Li, Hong Kong (CN)

Correspondence Address: Muncy, Geissler, Olds & Lowe, PLLC, 4000 Legato Road, Suite 310, FAIRFAX, VA, 22033, US

(21) Appl. No.: 12/851,103

(22) Filed: Aug. 5, 2010

(30) Foreign Application Priority Data
Aug. 5, 2009 (CN) 200920134627.0

(51) Int. Cl. H02K 5/173

(52) U.S. Cl. 310/90

(57) ABSTRACT

An automated manual transmission comprises a hydraulic pump and a motor for driving the hydraulic pump. The motor comprises a stator and a rotor rotatably mounted to the stator, the stator comprising a housing and a motor end cap fixed to the housing, the rotor comprising a rotatable shaft rotatably supported by a bearing which is installed to the end cap. The bearing comprises an inner race, an outer race, rollers disposed between the inner race and the outer race, and roll holder for holding the rollers. A ring-shaped seal member is arranged at one axial end of the bearing to seal the gap between the inner race and outer race. The end cap is molded at outer peripheral surface of the outer race.

### CROSS REFERENCE TO RELATED APPLICATIONS

This non-provisional patent application claims priority under 35 U.S.C. § 119(a) from Patent Application No. 200920134627.0 filed in The People's Republic of China on Aug. 5, 2009.

### FIELD OF THE INVENTION

This invention relates to an automated manual transmission and in particular, to an electric motor especially suitable for use with an automated manual transmission.

### BACKGROUND OF THE INVENTION

An electric motor usually comprises a rotatable shaft which is adapted to rotate when the motor is energized. The shaft is rotatably supported by bearings which are supported by non-rotating parts of the motor such as the motor housing and end caps. The bearings may include a ball bearing having an inner race, an outer race, balls disposed between the inner race and the outer race, and a cage for holding the balls. The inner race is press fitted onto the shaft, and the outer race is press fitted into the motor end cap. However, in some circumstances contaminants outside the motor can enter into the interior of the motor through a gap between the outer race and the end cap. For example, for an electric motor of an automated manual transmission (hereafter referred to as AMT), sometimes motor failure is caused by oil droplets which enter into the interior of the motor from the AMT by passing between the bearing and the end cap.

Therefore, there is a desire for an electric motor having an improved sealing between the bearing and the end cap, especially for an automated manual transmission.

### SUMMARY OF THE INVENTION

Accordingly, in one aspect thereof, the present invention provides a motor comprising a stator and a rotor rotatably mounted to the stator, the stator comprising a housing and an end cap fixed to the housing, the rotor comprising a shaft rotatably supported by a bearing which is supported by the end cap, wherein the bearing comprises an inner race, an outer race, rolling elements disposed between the inner race and the outer race, and a cage for holding the rolling elements; and the end cap is molded to an outer peripheral surface of the outer race.

Preferably, the shaft is press fitted to the inner race, and a ring-shaped seal member is arranged at an axial end of the bearing to seal the gap between the inner race and outer race.

Preferably, an engaging groove is formed in the outer peripheral surface of the outer race for engaging with the end cap.

Preferably, a rigid engaging collar is disposed in the engaging groove, outer edge of the engaging collar projecting out of the outer peripheral surface of the outer race and embedded in the end cap.

Preferably, the radial width of the engaging collar is at least twice the radial depth of the engaging groove.

Preferably, the engaging collar is a resilient C-shaped collar made of metal.

Preferably, a sealing groove is formed in an inner peripheral surface of the outer race or an outer peripheral surface of the inner race for receiving the seal member.

Preferably, only a part of the outer peripheral surface of the outer race is covered by the end cap.

Alternatively, the entire outer peripheral surface of the outer race is covered by the end cap.

According to a second aspect, the present invention provides an automated manual transmission comprising a hydraulic pump, and a motor as defined above.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a cross sectional view of an electrical motor as used in an automated manual transmission, according to one preferred embodiment of the present invention;

FIG. 2 is a sectional view of a bearing of the motor of FIG. 1;

FIG. 3 is a sectional view of the bearing of FIG. 2, after removal of seal members;

FIG. 4 is a view of an end cap of the motor of FIG. 1, illustrating the connection between the end cap, the bearing and the shaft;

FIG. 5 is a sectional view of a motor according to a second preferred embodiment of the present invention;

FIG. 6 is a sectional view of the bearing of FIG. 5; and

FIG. 7 is a schematic illustration of an automated manual transmission according to an embodiment of the present invention.

### DETAILED DESCRIPTION OF THE PREFERRED EMBODIMENTS

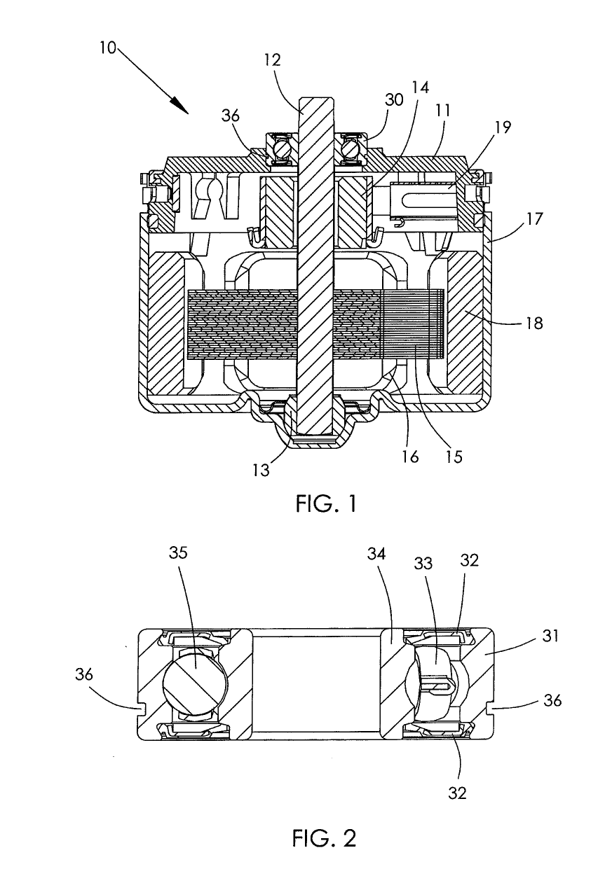

FIG. 7 illustrates an automated manual transmission (hereafter referred to as AMT) according to the present invention. The AMT comprises a motor 10 and a hydraulic pump 20. The hydraulic pump 20 is driven by a shaft 12 of the motor 10 directly or indirectly. The motor 10 will be described in detailed with reference to FIGS. 1 to 6.

FIG. 1 is a cross sectional view of a motor 10 according to an embodiment of the present invention. In this embodiment, motor 10 is a permanent magnet direct current (PMDC) motor, comprising a stator and a rotor rotatably mounted to the stator. The stator comprises a housing 17, magnets 18 fixed to inner surface of the housing, an end cap 11 installed to an axial end of the housing, and brush holders 19 installed to the housing 17 or end cap 11. The rotor comprises a rotatable shaft 12, a rotor core 15 and a commutator 14 fixed onto the shaft 12, and windings 15 wound about poles of the rotor core and electrically connected to segments of the commutator. The shaft 12 is rotatably supported by a first bearing 30 which is fixed onto the end cap 11 and by a second bearing fixed to a closed end of the housing 17. The first bearing 30 is a ball bearing and the second bearing 13 is a sintered bushing. One end of the shaft 12 extends out of the motor through the bearing 30 to drive a device such as a hydraulic pump of the AMT.

FIG. 2 is a cross sectional view of the bearing 30. The bearing 30 comprises an outer race 31, an inner race 34 surrounded by the outer race 31, rolling elements in the form of balls 35 disposed between the outer race 31 and the inner race 34, and a cage 33 for holding the balls 35. Two ring-shaped seal members 32 are installed at respective axial ends of the bearing 30 to seal the gap between inner race 34 and outer race 31. In the preferred embodiment, the seal member 32 is made of rubber. Alternatively, the seal member 32 can be made by other material, and the number of the seal ring 32 can be one although two is preferred.

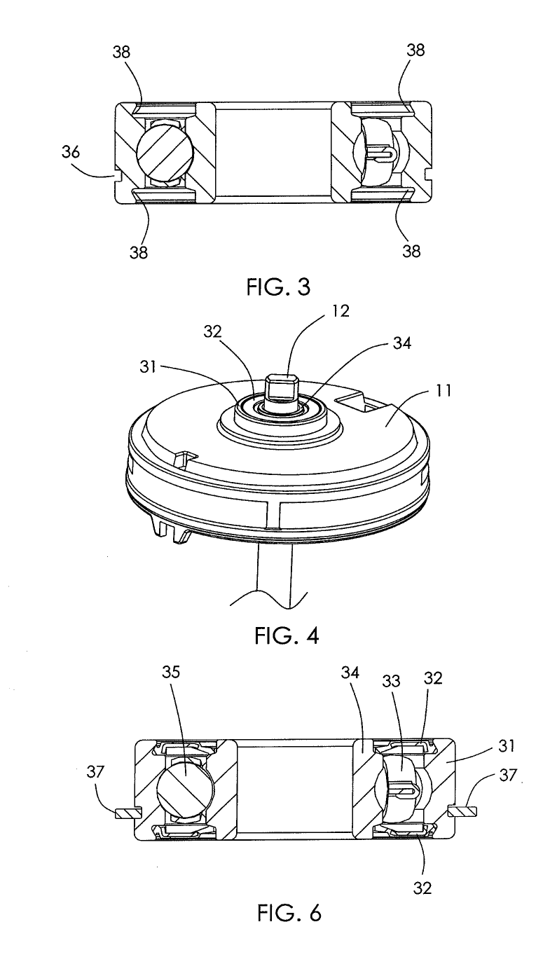

FIG. 3 is a view similar to FIG. 2 of the bearing 30 with the seal members 32 removed. A sealing groove 38 is formed at the inner peripheral surface of the outer race 31 for receiving the seal member 32. After the seal member 32 is installed, a resilient C-shaped retainer is fitted to the sealing groove 38. The C-shaped retainer has an outer diameter larger than the inner diameter of the seal groove 38 so that the retainer as well as the seal member 32 will not detach from the outer race 31. Alternatively, the seal groove can be formed in the outer peripheral surface of the inner race 34, and the C-shaped retainer has an inner diameter which is smaller than the outer diameter of the seal groove.

FIG. 4 illustrates the assembly of the end cap 11, shaft 12 and bearing 30. The inner race 34 is press fitted onto the shaft 12. Preferably, the inner diameter of the inner race 34 is a little smaller than the outer diameter of the shaft 12 so that the interface between the inner race 34 and the shaft 12 has a good leak tightness. The end cap 11 is molded onto the outer peripheral surface of the outer race 31 so that the interface between the end cap 11 and the outer race 31 also has a good leak tightness. As mentioned above, the gap between inner race 34 and outer race 31 is sealed by seal member 32, so that exterior contaminants such as oil droplets are kept from entering into the interior of the motor.

Referring to FIG. 3 and FIG. 4 again, to enhance the engagement and leak tightness between the end cap 11 and the bearing 30, a retaining structure is formed at the bearing 30. In this embodiment, the retaining structure comprises at least one engaging groove 36 formed in the outer peripheral surface of the outer race 31. When the end cap 11 is over molded onto the outer race, the engaging groove 36 is filled by material of the end cap 11. In this embodiment, a part of outer peripheral surface of the outer race 31 is covered by the end cap 11. Alternatively, the entire outer peripheral surface of the outer race may be covered by the end cap 11.

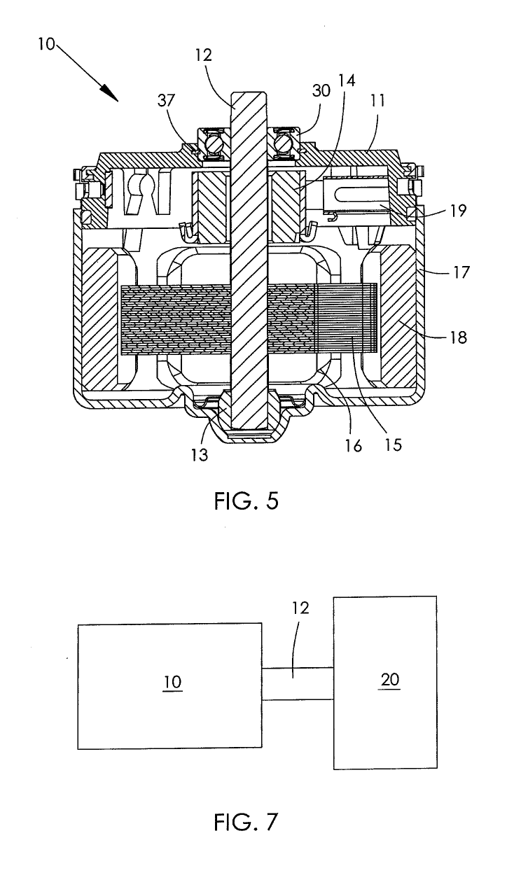

FIG. 5 is a cross sectional view, similar to FIG. 1, of a motor according to another embodiment of the present invention. FIG. 6 is a cross sectional view of a bearing of the motor of FIG. 5. Compared to the motor and bearing illustrated in FIG. 1 and FIG. 2, the retaining structure of the motor according to this embodiment further comprises a rigid engaging collar 37, which is disposed in the engaging groove 36. The engaging collar 37 is a resilient C-shaped rigid collar, made of metal. The inner diameter of the engaging collar 37 is a little smaller than the inner diameter of the engaging groove 36, so that inner edge of the engaging collar 37 engages with the engaging groove 36. Preferably, the radial width of the engaging collar 37 is at least twice the radial depth of the engaging groove 36, so that the outer edge of the engaging collar 37 projects out of the outer peripheral surface of the outer race 31 and is embedded in the molded end cap 11. The engaging collar 37 maybe a standard circlip.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A motor comprising a stator and a rotor rotatably mounted to the stator, the stator comprising a housing and an end cap fixed to the housing, the rotor comprising a shaft rotatably supported by a bearing which is supported by the end cap,
wherein the bearing comprises an inner race, an outer race, rolling elements disposed between the inner race and the outer race, and a cage for holding the rolling elements; and
the end cap is molded to an outer peripheral surface of the outer race.

2. The motor of claim 1, wherein the shaft is press fitted to the inner race, and a ring-shaped seal member is arranged at an axial end of the bearing to seal the gap between the inner race and outer race.

3. The motor of claim 1, wherein an engaging groove is formed in the outer peripheral surface of the outer race for engaging with the end cap.

4. The motor of claim 3, wherein a rigid engaging collar is disposed in the engaging groove, outer edge of the engaging collar projecting out of the outer peripheral surface of the outer race and embedded in the end cap.

5. The motor of claim 4, wherein the radial width of the engaging collar is at least twice the radial depth of the engaging groove.

6. The motor of claim 4, wherein the engaging collar is a resilient C-shaped collar made of metal.

7. The motor of claim 2, wherein a sealing groove is formed in an inner peripheral surface of the outer race or an outer peripheral surface of the inner race for receiving the seal member.

8. The motor of claim 1, wherein only a part of the outer peripheral surface of the outer race is covered by the end cap.

9. The motor of claim 1, wherein the entire outer peripheral surface of the outer race is covered by the end cap.

10. An automated manual transmission comprising a hydraulic pump, and the motor of claim 1.
